(19) United States
(12) Patent Application Publication
(10) Pub. No.: US 2024/0010185 A1
(43) Pub. Date: Jan. 11, 2024

(54) CONTROL SYSTEM FOR ELECTRIFIED VEHICLE

(71) Applicant: TOYOTA JODOSHA KABUSHIKI KAISHA, Toyota-shi Aichi-ken (JP)

(72) Inventor: Satoshi YASUDA, Nagakute-shi Aichi-ken (JP)

(73) Assignee: TOYOTA JODOSHA KABUSHIKI KAISHA, Toyota-shi Aichi-ken (JP)

(21) Appl. No.: 18/143,888

(22) Filed: May 5, 2023

(30) Foreign Application Priority Data
Jul. 7, 2022 (JP) 2022-109967

(51) Int. Cl. B60W 20/20; B60W 50/12

(52) U.S. Cl. CPC B60W 20/20; B60W 50/12

(57) ABSTRACT

The control system includes a first controller and a second controller. The second controller includes a processor that processes the first command value by a program to output an operation command value for the motor, and a logic circuit having a circuit structure that monitors a state index indicating a state of the power controller and converts the operation command value output into the drive signal. The first controller is configured to, in a case where a failure of the processor is detected when the electrified vehicle is started up, determine whether a limp home mode is executable, based on the state index, and, in a case where a determination is made that the limp home mode is executable, output a second command value based on the limp home mode to the logic circuit instead of the first command value.

### CROSS-REFERENCE TO RELATED APPLICATION

This application claims priority to Japanese Patent Application No. 2022-109967 filed on Jul. 7, 2022, incorporated herein by reference in its entirety.

### BACKGROUND

### 1. Technical Field

The technique disclosed in the present specification relates to a control system for an electrified vehicle.

### 2. Description of Related Art

Japanese Unexamined Patent Application Publication No. 2020-062930 (JP 2020-062930 A) discloses an electrified vehicle. The electrified vehicle is a hybrid electric vehicle, and includes a control system for controlling two motors. Note that the electrified vehicle in the present specification broadly means a vehicle having a motor for traveling that drives wheels. Examples of the electrified vehicle include a battery electrified vehicle, a fuel cell electric vehicle, and a plug-in hybrid electric vehicle, in addition to the hybrid electric vehicle.

### SUMMARY

Such a kind of a control system is often configured by a plurality of controllers. For example, the control system may include a first controller that decides a target output of a motor, a second controller that gives an operation command to a power controller, such as an inverter, in response to a command from the first controller. In this case, the first controller and the second controller are configured to communicate with each other, and control the motor in cooperation with each other.

In the control system described above, in a case where a failure has occurred in the second controller, the motor cannot be controlled even when the first controller is sound. However, there are many cases where the failure that has occurred in the second controller is a failure that has occurred in a part of the configuration of the second controller, and other configurations of the second controller are still available.

In this way, in a case where the failure has occurred in a part of the configuration of the second controller, the control of the motor with a limited configuration is needed. The present specification provides a technique of capable of causing the electrified vehicle to travel in a case where the failure of a part of the second controller is detected when the electrified vehicle is started up.

The present specification is embodied in a control system for an electrified vehicle. A first aspect of the disclosure relates to a control system including a power controller, a first controller, and a second controller. The power controller is configured to adjust a power supplied to a motor of the electrified vehicle. The first controller is configured to output a first command value indicating a target output of the motor. The second controller is configured to communicate with the first controller and output a drive signal to the power controller based on the first command value output from the first controller. The second controller includes a processor, and a logic circuit. The processor is configured to communicate with the first controller and process the first command value output from the first controller by a program to output an operation command value for the motor. The logic circuit has a circuit structure configured to monitor a state index indicating a state of the power controller and convert the operation command value output from the processor into the drive signal. The logic circuit is configured to communicate with the first controller without passing through the processor and output the state index to the first controller. The first controller is configured to, in a case where a failure of the processor is detected when the electrified vehicle is started up, determine whether or not a limp home mode for causing the electrified vehicle to travel in a limp home manner is executable, based on the state index output from the logic circuit, and, in a case where a determination is made that the limp home mode is executable, output a second command value based on the limp home mode to the logic circuit instead of the first command value.

With the configuration described above, in a case where the failure of the processor is detected when the electrified vehicle is started up, the first controller determines whether or not the limp home mode for causing the electrified vehicle to travel in a limp home manner is executable, based on the state index output from the logic circuit. Then, in a case where a determination is made that the limp home mode is executable, the first controller outputs the second command value based on the limp home mode to the logic circuit instead of the first command value. Accordingly, the control system can cause the electrified vehicle to travel in a case where the failure of the processor is detected when the electrified vehicle is started up.

In a second aspect, according to the first aspect, the power controller may include an inverter.

In a third aspect, according to the first or second aspect, the state index may be at least one of a temperature of the power controller, a current value of a current output from the power controller, and a power supply state of a control board of the power controller.

In a fourth aspect, according to any one of the first to third aspects, the first command value may be a torque command value indicating a torque to be output from the motor. Additionally or alternatively, the operation command value may be a current command value indicating a current to be supplied to the motor by the power controller.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a circuit configuration of a control system;

FIG. 2 shows a communication sequence diagram between a host ECU and an ASIC of a motor ECU; and

FIG. 3 shows a sequence diagram showing continuation of FIG. 2.

### DETAILED DESCRIPTION OF EMBODIMENTS

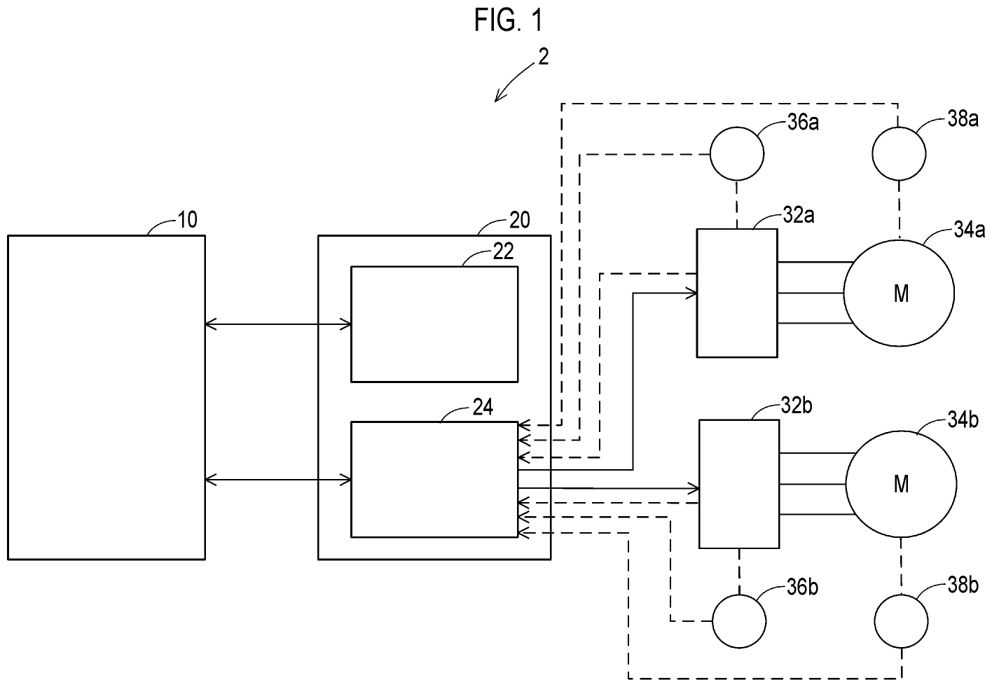

Circuit Configuration of Control System 2; FIG. 1

A control system 2 of the present embodiment is mounted on an electrified vehicle (for example, an electric vehicle, a hybrid electric vehicle, a plug-in hybrid electric vehicle, or a fuel cell electric vehicle) including a motor for traveling that drives wheels. As shown in FIG. 1, the control system 2 includes a host electronic control unit (ECU) 10, a motor ECU 20, two inverters 32a, 32b, and two motors 34a, 34b for traveling.

The host ECU 10 outputs a torque command value indicating a target output of each of the motors 34a, 34b, based on an accelerator operation amount, for example. The motor ECU 20 is configured to communicate with the host ECU 10. The motor ECU 20 outputs drive signals to the inverters 32a, 32b based on the torque command values output from the host ECU 10.

The motor ECU 20 includes a microcomputer 22 and an application specific integrated circuit (ASIC) 24. The microcomputer 22 is configured to communicate with the host ECU 10. The microcomputer 22 processes the torque command values output from the host ECU 10 by a program to output current command values for the motors 34a, 34b. The microcomputer 22 includes, for example, a central processing unit (CPU), and the CPU can process the torque command values output from the host ECU 10 by the program.

The ASIC 24 has a circuit structure that converts the current command values output from the microcomputer 22 into the drive signals. In particular, the circuit structure of the ASIC 24 is a circuit structure for controlling the motors 34a, 34b, and includes, for example, a resolver digital converter that converts rotation angles from angle sensors 38a, 38b to be described below into digital values. The ASIC 24 converts the current command values into the drive signals by using the rotation angles and the like. Note that, although not shown, the microcomputer 22 and the ASIC 24 are configured to communicate with each other.

The inverters 32a, 32b convert direct current power output from a battery (not shown) into three-phase alternating current power, and supply the converted three-phase alternating current power to the motors 34a, 34b. That is, each of the inverters 32a, 32b is a device that adjusts the power supplied to the motors 34a, 34b. The electrified vehicle can travel by driving the motors 34a, 34b. Note that the inverters 32a, 32b can also convert regenerated power (three-phase alternating current power) of each of the motors 34a, 34b into the direct current power, and supply the converted direct current power to the battery (not shown). Since the specific circuit configuration of the inverters 32a, 32b is well known, the detailed description thereof will be omitted.

Current sensors 36a, 36b are connected to the inverters 32a, 32b, respectively. The current sensors 36a, 36b are sensors that detect current values of the output currents of the inverters 32a, 32b (that is, the current supplied to each of the motors 34a, 34b), respectively. The current value detected by each of the current sensors 36a, 36b is output to the ASIC 24.

The angle sensors 38a, 38b are connected to the motors 34a, 34b, respectively. The angle sensors 38a, 38b are resolvers, for example. The angle sensors 38a, 38b detect the rotation angles of (rotors) of the motors 34a, 34b, respectively. The rotation angle detected by each of the angle sensors 38a, 38b is input to the ASIC 24.

The ASIC 24 is further configured to communicate with the host ECU 10 without passing through the microcomputer 22. The ASIC 24 is configured to repeatedly output (for example, each time a predetermined time elapses) state indexes indicating states of the inverters 32a, 32b, such as the current values detected by the current sensors 36a, 36b. The state indexes include temperatures of the inverters 32a, 32b, power supply states of control boards of the inverters 32a, 32b, and the like, in addition to the current value. In the present embodiment, the state indexes are used by the host ECU 10 in a determination as to whether or not a limp home mode to be described below is executable.

As described above, in the control system 2 of the present embodiment, the host ECU 10 and the motor ECU 20 (that is, the microcomputer 22 and the ASIC 24) control the inverters 32a, 32b and the like in cooperation with each other. Specifically, first, the host ECU 10 outputs the torque command values that are the target outputs of the motors 34a, 34b based on the accelerator operation amount and the like, to the microcomputer 22. The microcomputer 22 processes the torque command values by the program to output the current command values for the motors 34a, 34b to the ASIC 24. The ASIC 24 converts the current command values into the drive signals.

In such a control system 2, a situation is assumed in which a failure has occurred in a part of a configuration of the motor ECU 20 (specifically, the microcomputer 22). In such a situation, the microcomputer 22 does not acquire the torque command values output from the host ECU 10. Therefore, the ASIC 24 cannot acquire the current command values from the microcomputer 22, and cannot output the drive signals as a result. That is, normally, in a case where the failure has occurred in the microcomputer 22 in such a control system 2, the control system 2 cannot cause the electrified vehicle to travel.

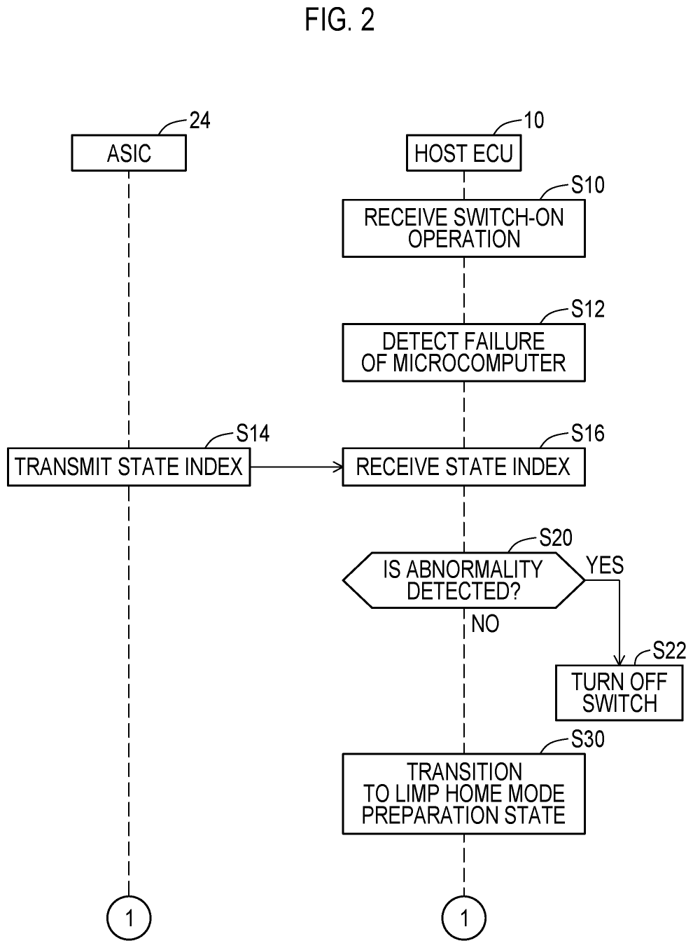

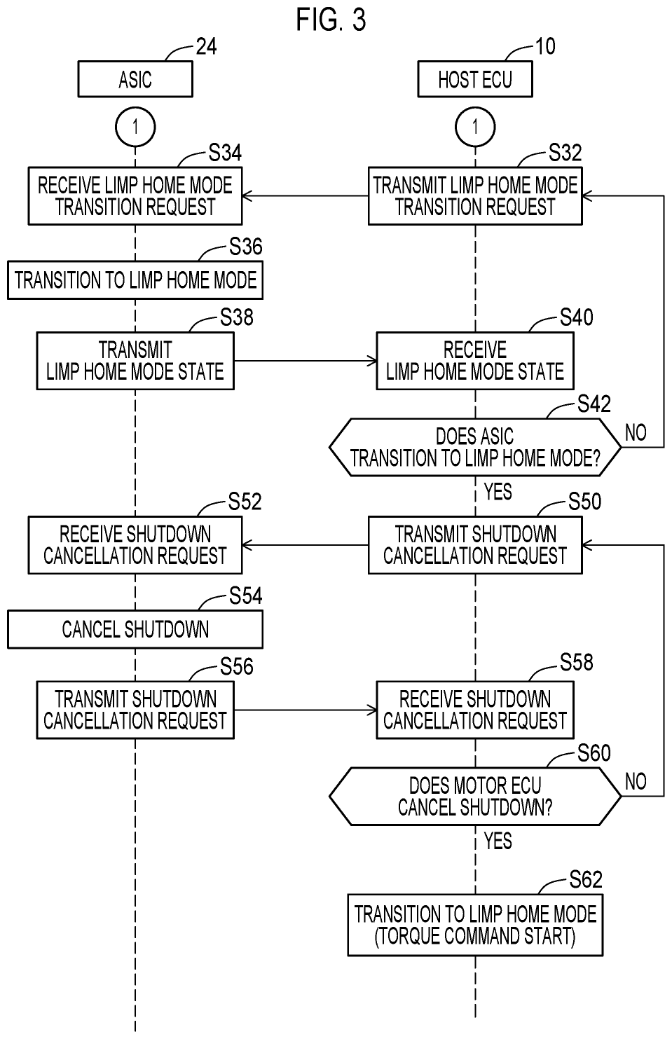

Therefore, in the control system 2 of the present embodiment, in a case where the failure of the microcomputer 22 is detected when the electrified vehicle is started up, the host ECU 10 determines whether or not the limp home mode for causing the electrified vehicle to travel in a limp home manner is executable, based on the state indexes output from the ASIC 24. Then, in a case where a determination is made that the limp home mode is executable, the host ECU 10 outputs the torque command values based on the limp home mode to the ASIC 24 instead of the microcomputer 22. The ASIC 24 has a control logic (that is, the circuit structure) for causing the electrified vehicle to travel in a limp home manner. That is, the ASIC 24 also has a circuit structure that converts the torque command values output from the host ECU 10 into the drive signals. As a result, even in a case where the failure of the microcomputer 22 is detected when the electrified vehicle is started up, the electrified vehicle can travel in a limp home manner. Detailed processing will be described below with reference to FIGS. 2 and 3.

Specific Processing; FIGS. 2 and 3

Next, specific processing of the present embodiment will be described with reference to FIGS. 2 and 3. In an initial state of FIG. 2, the failure has occurred in the microcomputer 22 of the motor ECU 20. In FIG. 2, a situation is assumed in which the electrified vehicle is started up in a situation in which the failure has occurred in the microcomputer 22.

In S10 of FIG. 2, the host ECU 10 receives a switch-on operation for starting up the electrified vehicle from a user (S10 of FIG. 2). In this case, the host ECU 10 attempts to execute start-up check processing with the microcomputer 22. The start-up check processing is processing for checking whether or not the electrified vehicle can travel in a normal traveling mode. However, in this case, since the failure has occurred in the microcomputer 22, the start-up check processing is not appropriately executed. Therefore, the host ECU 10 detects the failure of the microcomputer 22 in S12.

Also, although not shown, the host ECU 10 transmits a shutdown request to the ASIC 24 in a case where the failure of the microcomputer 22 is detected in S12. The reason of the transmission described above is that, since the failure has occurred in the microcomputer 22, the microcomputer 22 and the ASIC 24 cannot control the motors 34a, 34b in cooperation with each other (that is, cannot cause the electrified vehicle to travel in the normal traveling mode). In a case where the shutdown request is received, the ASIC 24 shuts down the circuit for outputting the drive signals to the inverters 32a, 32b.

As described above, the ASIC 24 is configured to output the state indexes to the host ECU 10. The ASIC 24 transmits the state indexes to the host ECU 10 in S14. Note that, in a modification example, in a case where the failure of the microcomputer 22 is detected, the host ECU 10 may transmit a transmission request of the state indexes to the ASIC 24. Then, in a case where the transmission request is received from the host ECU the ASIC 24 may transmit the state indexes to the host ECU 10 in S14. In addition to the state indexes, the ASIC 24 may transmit other information, such as temperatures of components of the electrified vehicle, such as a transaxle and the motor, to the host ECU 10.

In a case where the state indexes are received from the ASIC 24 in S16, the host ECU 10 determines whether or not an abnormality has occurred in each of the inverters 32a, 32b based on the state indexes (that is, the current value, the temperature, and the power supply state of the inverter) in S20. For example, in a case where the temperature of at least any one of the inverters 32a, 32b is higher than a threshold temperature, the host ECU detects the abnormality has occurred in the inverter. In a case where the abnormality is detected, the host ECU 10 determines that the limp home mode is not executable (YES in S20), proceeds to S22, and turns off the switch of the electrified vehicle. The reason of the processing described above is that, in a situation in which the abnormality is detected, causing the electrified vehicle to travel is not desirable. On the other hand, in a case where no abnormality is detected, the host ECU 10 determines that the limp home mode is executable (NO in S20), and proceeds to S30.

The host ECU 10 transitions to a limp home mode preparation state in S30. The limp home mode preparation state is a mode in which various pieces of processing are executed with the ASIC 24 in order to cause an operation mode of the host ECU 10 to transition from the normal traveling mode to the limp home mode. Various pieces of processing executed with the ASIC 24 in order to transition to the limp home mode will be described below with reference to FIG. 3.

Continuation of FIG. 2; FIG. 3

In a case where the host ECU 10 transitions to the limp home mode preparation state in S30 of FIG. 2, the host ECU 10 transmits a limp home mode transition request to the ASIC 24 in S32 of FIG. 3. The limp home mode transition request is a signal for requesting the ASIC 24 to cause the state of the ASIC 24 to transition to the limp home mode.

In a case where the limp home mode transition request is received from the host ECU 10 in S34, the ASIC 24 transitions to the limp home mode in S36, and transmits a limp home mode state indicating that the ASIC 24 has transitioned to the limp home mode to the host ECU 10 in S38. The ASIC 24 is configured to convert the torque command values output from the host ECU 10 into the drive signals in the limp home mode. In particular, in the limp home mode, the output is limited as compared to the normal traveling mode.

In addition, after the limp home mode transition request is transmitted to the ASIC 24 in S32, the host ECU 10 determines in S42 whether or not the ASIC 24 has transitioned to the limp home mode. Specifically, the host ECU 10 determines whether or not the limp home mode state is received from the ASIC 24. In a case where the limp home mode state has been received from the ASIC 24, the host ECU 10 determines that the ASIC 24 has transitioned to the limp home mode (YES in S42), and proceeds to S50. On the other hand, in a case where the limp home mode state has not been received from the ASIC 24, the host ECU 10 determines that the ASIC 24 does not transition to the limp home mode (NO in S42), and executes the processing of S32 again. For example, in a case where the limp home mode transition request is not appropriately transmitted from the host ECU 10 to the ASIC 24, or in a case where there is a relatively long time lag from when the limp home mode transition request is transmitted to when the limp home mode state is received, a NO determination can be made in S42.

The host ECU 10 transmits a shutdown cancellation request to the ASIC 24 in S50. As described above, the host ECU 10 has transmitted the shutdown request to the ASIC 24 due to the failure of the microcomputer 22, but in this case, the electrified vehicle can be caused to travel in a limp home manner in the limp home mode even in a case where the failure has occurred in the microcomputer 22. Therefore, the host ECU 10 transmits the shutdown cancellation request to the ASIC 24 in order to cause the electrified vehicle to travel in a limp home manner in the limp home mode.

In a case where the shutdown cancellation request is received from the host ECU 10 in S52, the ASIC 24 cancels the shutdown in S54. That is, the ASIC 24 cancels the shutdown of the circuit for outputting the drive signals to the inverters 32a, 32b. Therefore, the ASIC 24 is in a state of capable of outputting the drive signals based on the limp home mode to the inverters 32a, 32b.

Also, in S56, the ASIC 24 transmits a shutdown cancellation state indicating that the ASIC 24 has cancelled the shutdown to the host ECU 10.

Also, after the shutdown cancellation request is transmitted to the ASIC 24 in S50, the host ECU 10 determines in S60 whether or not the ASIC 24 has cancelled the shutdown. Specifically, the host ECU 10 determines whether or not the shutdown cancellation state has been received from the ASIC 24. In a case where the shutdown cancellation state has been received from the ASIC 24, the host ECU 10 determines that the ASIC 24 has canceled the shutdown (YES in S60), and proceeds to S62. On the other hand, in a case where the shutdown cancellation state has not been received from the ASIC 24, the host ECU 10 determines that the ASIC 24 has not canceled the shutdown (NO in S60), and executes the processing of S50 again. For example, in a case where the shutdown cancellation request is not appropriately transmitted from the host ECU 10 to the ASIC 24, or in a case where there is a relatively long time lag from when the shutdown cancellation request is transmitted to when the shutdown cancellation state is received, a NO determination can be made in S60.

The host ECU 10 transitions to the limp home mode in S62. In the limp home mode, an upper limit value of the torque command value is set lower than in the normal traveling mode. In a case of transitioning to the limp home mode, the host ECU 10 outputs the torque command values based on the limp home mode to the ASIC 24 instead of the microcomputer 22 based on the accelerator operation amount and the like. As a result, the ASIC 24 converts the torque command values output from the host ECU 10 into the drive signals and supplies the converted drive signal to the inverters 32a, 32b. As a result, even in a situation in which the failure has occurred in the microcomputer 22 of the motor ECU 20, the electrified vehicle can be caused to travel in a limp home manner in the limp home mode.

With the configuration of the present embodiment, in a case where the failure of the microcomputer 22 of the motor ECU 20 is detected when the electrified vehicle is started up, the host ECU 10 determines whether or not the limp home mode for causing the electrified vehicle to travel in a limp home manner is executable, based on the state indexes output from the ASIC 24 (S14 of FIG. 2) (S20). Then, in a case where a determination is made that the limp home mode is executable, the host ECU 10 outputs the torque command values based on the limp home mode to the ASIC 24 instead of the torque command values output from the host ECU 10 to the microcomputer 22. Accordingly, the control system 2 can cause the electrified vehicle to travel in a case where the failure of the microcomputer 22 is detected when the electrified vehicle is started up.

The host ECU 10 and the motor ECU 20 are examples of a “first controller” and a “second controller” of the present technique, respectively. The microcomputer 22 and the ASIC 24 are examples of a “processor” and a “logic circuit” of the present technique, respectively. The inverters 32a, 32b are an example of a “power controller” of the present technique. The torque command value output from the host ECU 10 to the microcomputer 22 and the torque command value output from the host ECU 10 to the ASIC 24 are examples of a “first command value” and a “second command value” of the present technique, respectively. The current command value output from the microcomputer 22 to the ASIC 24 is an example of an “operation command value” of the present technique.

The modification examples of the embodiment described above are described below. The processing of S38, S40, S56, and S58 in FIG. 3 can be omitted. As described above, the ASIC 24 repeatedly outputs the state indexes to the host ECU 10. The ASIC 24 may transmit information (for example, the output upper limit value of the ASIC 24) for enabling the host ECU 10 to determine the state of the ASIC 24 (for example, the limp home mode state or the shutdown cancellation state) together with the state indexes to the host ECU 10. The host ECU 10 may execute the processing of S42, S60, and the like based on these pieces of information.

In the control system 2 of the present embodiment, the host ECU 10 is configured to output the torque command values to the motor ECU 20. The torque command values in the present embodiment are examples of the first command values indicating the target outputs of the motors 34a, 34b. Note that, in another embodiment, the host ECU 10 may output, as the first command value, other indexes indicating the target outputs of the motors 34a, 34b instead of the torque command values to the motor ECU 20.

In the control system 2 of the present embodiment, the microcomputer 22 of the motor ECU 20 is programmed to output the current command values to the ASIC 24 based on the torque command values (or other first command values). Note that the current command values in the present embodiment are examples of the operation command values for the motors 34a, 34b, and do not limit the operation command values. In another embodiment, the microcomputer 22 may be programmed to decide other operation command values for the motors 34a, 34b based on the torque command values (or other first command values) and output the decided operation command values to the ASIC 24.

Although the specific examples of the technique disclosed in the present specification have been described above in detail, these specific examples are merely examples and do not limit the scope of the claims. The technique described in the scope of the claims include various modifications and changes of the specific examples described above. The technical elements described in the present specification or the drawings exhibit the technical usefulness alone or in various combinations, and are not limited to the combination described in the claims at the time of filing of application. Also, the technique described in the present specification or the drawings can achieve a plurality of purposes at the same time, and achieving one of the purposes has technical usefulness.

What is claimed is:

1. A control system for an electrified vehicle, the control system comprising:
a power controller configured to adjust a power supplied to a motor of the electrified vehicle;
a first controller configured to output a first command value indicating a target output of the motor; and
a second controller configured to communicate with the first controller and output a drive signal to the power controller based on the first command value output from the first controller, wherein:
the second controller includes
a processor configured to communicate with the first controller and process the first command value output from the first controller by a program to output an operation command value for the motor, and
a logic circuit having a circuit structure configured to monitor a state index indicating a state of the power controller and convert the operation command value output from the processor into the drive signal;
the logic circuit is configured to communicate with the first controller without passing through the processor and output the state index to the first controller; and
the first controller is configured to
in a case where a failure of the processor is detected when the electrified vehicle is started up, determine whether or not a limp home mode for causing the electrified vehicle to travel in a limp home manner is executable, based on the state index output from the logic circuit, and
in a case where a determination is made that the limp home mode is executable, output a second command value based on the limp home mode to the logic circuit instead of the first command value.

2. The control system according to claim 1, wherein the power controller includes an inverter.

3. The control system according to claim 1, wherein the state index is at least one of a temperature of the power controller, a current value of a current output from the power controller, and a power supply state of a control board of the power controller.

4. The control system according to claim 1, wherein:
the first command value is a torque command value indicating a torque to be output from the motor; and
the operation command value is a current command value indicating a current to be supplied to the motor by the power controller.
